(19) United States
(12) Patent Application Publication
(10) Pub. No.: US 2017/0126767 A1
(43) Pub. Date: May 4, 2017

(54) METHOD FOR SWITCHING LIVE AUDIOS, STREAMING SERVER AND CLIENT

(71) Applicants: Le Holdings (Beijing) Co., Ltd., Beijing (CN); Le Shi Zhi Xin Electronic Technology (Tian Jin) Limited, Beijing (CN)

(72) Inventor: Wei Cai, Beijing (CN)

(21) Appl. No.: 15/241,140

(22) Filed: Aug. 19, 2016

Related U.S. Application Data
(63) Continuation of application No. PCT/CN2016/082537, filed on May 18, 2016.

(30) Foreign Application Priority Data
Oct. 29, 2015 (CN) 201510726708.X

(51) Int. Cl. H04L 29/06; H04N 21/2187; H04N 21/8547; G06F 3/16; H04N 21/439

(52) U.S. Cl. CPC H04L 65/60; G06F 3/165; H04N 21/4394; H04N 21/8547; H04N 21/2187

(57) ABSTRACT

The present application discloses a method for switching live audios, a streaming server and a client, wherein the method includes: acquiring live audios on different channels, and distributing a corresponding live address for each live audio; adding the description information of each live audio and a corresponding relation between the description information of the live audio and the live address in live metadata; sending the live metadata to a client, and detecting a selection instruction returned from the client; if the selection instruction returned from the client is received in a predetermined time, setting the live address corresponding to the description information of the live audio which is pointed by the selection instruction as the current live address; and sending the live audio corresponding to the current live address to the client.

### CROSS-REFERENCE TO RELATED APPLICATIONS

This application is a continuation of International Application No. PCT/CN2016/082537, filed May 18, 2016, which claims priority to Chinese Patent Application No. 201510726708.X, filed Oct. 29, 2015, the entire contents of which are incorporated herein by reference.

### TECHNICAL FIELD

Some embodiments of the present disclosure relate to the field of audio and video technologies, and more particularly, to a method for switching live audios, a streaming server and a client.

### BACKGROUND

In live webcast, a program provider uploads pre-configured live audio signals or live audio and video signals to a server through a network, and publishes to users on a website. A live audio and a live video in the current live webcast programs are all fixedly configured and are sole. The user after selecting to view a certain live webcast program, can only passively receive the single live audio and cannot select the live audio independently.

While, it is needed to switch among different live webcast program providers to select a live audio favored by the users, which will apparently reduce the user experience greatly.

### SUMMARY

Some embodiments of the present disclosure provide a method for switching live audios, a streaming server and a client, for solving the problem in the prior art that the users cannot select the live audios in the same live webcast independently.

Some embodiments of the present disclosure provide a method for switching live audios, including:

acquiring live audios on different channels, and distributing a corresponding live address for each live audio;

constructing live metadata, and adding the description information of each live audio and a corresponding relation between the description information of the live audio and the live address in the live metadata;

sending the live metadata to a client, and detecting a selection instruction returned from the client;

if the selection instruction returned from the client is received in a predetermined time, setting the live address corresponding to the description information of a live audio which is pointed by the selection instruction as the current live address; and

sending the live audio corresponding to the current live address to the client.

Some embodiments of the present disclosure provide a streaming server, including:

a data acquisition unit configured to acquire live audios on different channels, and distribute a corresponding live address for each live audio;

a metadata generation unit configured to construct live metadata, and add the description information of each live audio and a corresponding relation between the description information of the live audio and the live address in the live metadata;

an interactive unit configured to send the live metadata to a client, and detect a selection instruction returned from the client;

an instruction response unit configured to, if the selection instruction returned from the client is received in a predetermined time, set the live address corresponding to the description information of a live audio which is pointed by the selection instruction as the current live address; and

a data sending unit configured to send the live audio corresponding to the current live address to the client.

Some embodiments of the present disclosure provide a method for switching live audios, including:

requesting live metadata from a streaming server, and displaying the description information of live audios on different channels included in the live metadata;

detecting whether an inputted selection instruction exists;

if the inputted selection instruction is detected in a predetermined time, generating a selection instruction according to the description information of a live audio which is pointed by the inputted selection instruction, and notifying the selection instruction to the streaming server;

connecting the live address corresponding to the selection instruction returned from the streaming server; and

acquiring the corresponding live audio from the streaming server according to the live address, and playing the corresponding live audio.

Some embodiments of the present disclosure provide a client, including:

a data request unit configured to request live metadata from a streaming server, and display the description information of live audios on different channels included in the live metadata;

an instruction detecting unit configured to detect whether an inputted selection instruction exists;

an instruction transmission unit configured to, if the inputted selection instruction is detected in a predetermined time, generate a selection instruction according to the description information of a live audio which is pointed by the inputted selection instruction, and notify the selection instruction to the streaming server;

a data connection unit configured to connect the live address corresponding to the selection instruction returned from the streaming server; and

a data display unit configured to acquire the corresponding live audio from the streaming server according to the live address, and play the corresponding live audio.

According to the method for switching audios, the streaming server and device provided by some embodiments of the present disclosure, the live audios on different channels are acquired through the streaming server, and the corresponding relation between the description information of the live audio and the live address is added in the live metadata; a user may select the description information of the live audio favored thereof independently in the description information of the live audio displayed by the client, and the streaming server will set the live address corresponding to the description information of the live audio selected by the user as the current live address according to the selection of the user; when the selection behavior of the user occurs in the playing process of the current live audio, the client will also synchronously switch two live audios. The streaming server provides the live audios on different channels for the client, while the client is interactive with the user and acquires the live audio favored by the user from the streaming server, and the technical effect that the user selects the live audios in the same live webcast independently is together implemented by the streaming server and the client.

### BRIEF DESCRIPTION OF THE DRAWINGS

In order to explain the technical solutions in some embodiments of the disclosure or in the prior art more clearly, the drawings used in the descriptions of some embodiments or the prior art will be simply introduced hereinafter. It is apparent that the drawings described hereinafter are merely some embodiments of the disclosure, and those skilled in the art may also obtain other drawings according to these drawings without going through creative work.

FIG. 1 is a flow chart of a method for switching audios of the present disclosure;

FIG. 2 is a flow chart of an embodiment of the method for switching audios of the present disclosure;

FIG. 3 is a structural schematic diagram of a streaming server of the present disclosure;

FIG. 4 is a flow chart of the method for switching audios of the present disclosure;

FIG. 5 is a flow chart of some embodiments of the method for switching audios of the present disclosure; and

FIG. 6 is a structural schematic diagram of a client of the present disclosure.

### DETAILED DESCRIPTION

To make the objects, technical solutions and advantages of some embodiments of the present disclosure more clearly, the technical solutions of the present disclosure will be clearly and completely described hereinafter with reference to some embodiments and drawings of the present disclosure. Apparently, some embodiments described are merely partial embodiments of the present disclosure, rather than all embodiments. Other embodiments derived by those having ordinary skills in the art on the basis of some embodiments of the disclosure without going through creative efforts shall all fall within the protection scope of the present disclosure.

Some embodiments of the present disclosure provide a method for switching live audios, a streaming server and a client, which may be applied to a live webcast scenario. When people are watching a live webcast program, especially a sports competition, all the viewers share the commentary of the same host in front of a screen only; however, the preferences of viewers of different sexes, ages and places are different mutually. Different viewers have respective standpoints on the same live program, and the viewers naturally prefer the commentary of the host having the standpoints consistent with themselves. It has only to switch to and select among different live webcast providers according to the present solution, which not only wastes the time and flow, but also may miss excellent competition moments during the switching buffer process. The method for switching live audios, the streaming server and the client provided by some embodiments of the present disclosure are just intended to solve the problem that the user cannot select the live audio in the unified live program independently. Live audios on different channels are acquired through a network distribution manner, and the live audios on different channels are distributed through CDN, and the live audio selected by the user independently is sent to the client and played according to the selection instruction or switching instruction acquired by the client. In this way, the user can select the live audio in the same live program independently, and synchronously switching of the live audios, so that the user experience is greatly improved.

It should be illustrated that the method for switching live audios, the streaming server and the client provided by some embodiments of the present disclosure may also be applied to other scenarios, and will not be defined herein.

In order to make the objects, technical solutions and advantages of the present disclosure more clear, the present disclosure will be further described in details hereinafter with reference to the drawings and specific embodiments.

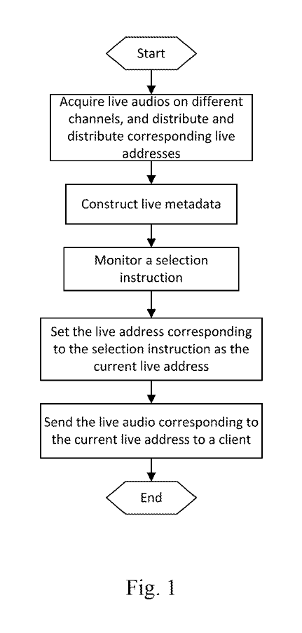

Referring to FIG. 1, some embodiments of the present disclosure provide a method for switching live audios, including the following steps.

In step 101, live audios on different channels are acquired, and a corresponding live address is distributed for each live audio.

In step 102, live metadata is constructed and the description information of each live audio and a corresponding relation between the description information of the live audio and the live address are added in the live metadata.

In step 103, the live metadata is sent to a client, and a selection instruction returned from the client is detected; if the selection instruction returned from the client is received in a predetermined time, then it needs to skip to step 104.

In step 104, the live address corresponding to the description information of a live audio which is pointed by the selection instruction is set as the current live address.

In step 105, the live audio corresponding to the current live address is sent to the client.

Wherein, in step 101, the live audios on different channels may be collected adopting a network distribution manner, and hosts may distribute in the same position or different positions. Because the audios of the hosts are not collected in the same apparatus, a streaming server needs to acquire the live audios of different hosts respectively in step 101, and publishes each live audio acquired to a live address distributed therefor.

In step 102, and step 103, the live metadata includes the description information of each live audio and the corresponding relation between the description information of the live audio and the live address. The live metadata will be sent to the client, and the description information of each live audio in the live metadata will be displayed in a client, and a user may see the description information of each live audio, for example, a code rate, a sampling rate, an encoder type, host introduction, or the like, and the host introduction may further include: such information cared by the user as the avatar image, name, brief introduction, style, popularity degree and type of the host, etc. The user may find the host favored thereof, and click the description information of the live audio of the host. Then the corresponding live address will be found in step 103 according to the selection of the user and the corresponding relation between the description information of the live audio and the live address.

In step 103, the live metadata is sent after a connection request of the client is received. The streaming server includes live audios on different channels; therefore, after a connection between the streaming server and the client is established, neither the streaming server nor the client can determine which live audio shall be sent or played.

While there are various implementation manners of determining the live audio to be sent or played after the connection is established:

for example, it may be random playing, or may be as described in step 104, when the selection instruction returned from the client is received in the predetermined time, the live address corresponding to the description information of the live audio which is pointed by the selection instruction is set as the current live address. The predetermined time is a reaction time reserved for the user, for example, the predetermined time may be 5 s or other duration, and advertisements may be played in the predetermined time. If the selection instruction returned from the client is not received in the predetermined time, it may send a prompt to the user by the client, or continue to wait until the user inputs a selection instruction, and this will not be defined by the present disclosure. The selection instruction may be the clicking of the user on the description information of the live audio or a selection instruction in other manners inputted by the user, and will not be defined herein. According to the description information of the live audio which is pointed by the selection instruction, the address corresponding to the description information of the live audio will be set as the current live address in step 104, and the live audio will be published to the current live address in step 105, while the client may also be connected to the current live address, so that the user may hear the live audio selected thereof.

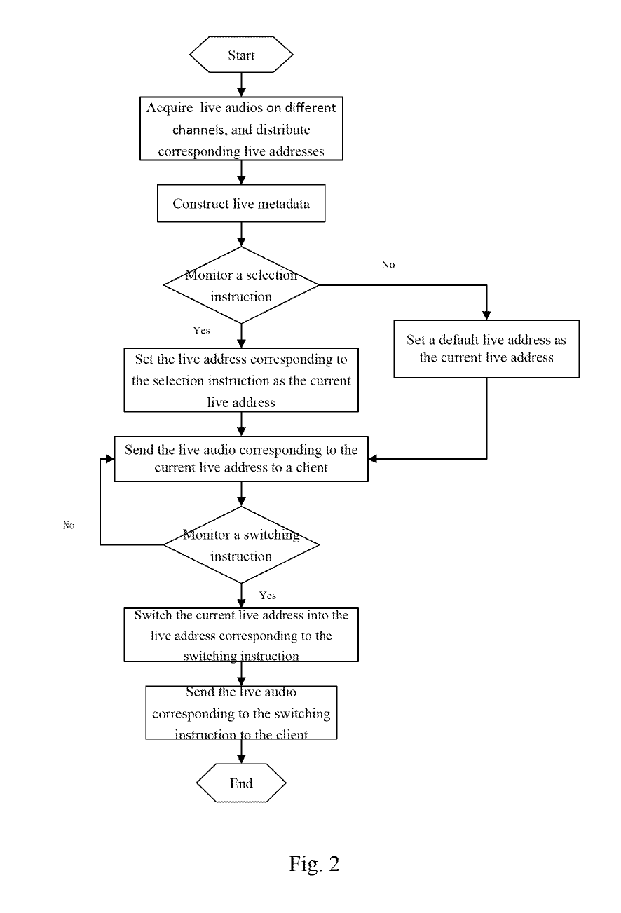

Referring to FIG. 2, if the selection instruction returned from the client is not received in the predetermined time after step 103, besides the processing mode as described above, it may also skip to step 106 after step 103.

In step 106, a default live address is set as the current live address, wherein the default live address is preset and corresponding to the description information of one of live audios in the live metadata.

As described above, the predetermined time is a reaction time reserved for the user, while the data returned is not acquired in a long time, then the user will consider that the connection is failed, which affects the user experience. Therefore, the predetermined time cannot be too long; moreover, after exceeding the predetermined time, the streaming server needs to send data to a client server initiatively to maintain the user experience. According to step 106, the streaming server will set one of the plurality of live addresses as a default live address; if the selection instruction returned from the client is not received in the predetermined time, then the default live address is directly served as the current live address, and it will skip to step 105 after step 106 to send the corresponding live audio to the client.

Referring to FIG. 2, after the steps 101˜105 as shown in FIG. 1, the method for switching live audios provided by the embodiment of the present disclosure further includes the following steps.

In step 107, a switching instruction returned from the client is detected.

In step 108, the current live address is switched into the live address corresponding to the description information of a live audio which is pointed by the switching instruction according to the description information of the live audio which is pointed by the switching instruction.

In step 109, the live audio corresponding to the live address corresponding to the description information of the live audio which is pointed by the switching instruction is sent to the client.

Based on the steps 101˜105, the streaming server has sent one of live audios to the client, and the client also starts playing the live audio; while, if the user finds that the live audio is not the one expected thereof during the playing process of the current live audio, then the user may initiate to switch the live audio through the client, and the switching processing of the live audio is as follows.

In step 107, the description information of each live audio in the live metadata is continuously displayed in the client, and the user may click the description information at any time; if the user clicks the description information of other live audio in the playing process of the current live audio, a switching instruction will be generated. Certainly, the switching instruction may also be generated using other manners, which will not be defined herein. Step 107 is just to detect the switching instruction occurred during the playing process of the current live audio.

After the switching instruction is detected, then step 108 is performed to switch the current live address into a new live address which is pointed by the switching instruction, and then the new live address just becomes the current live address. Step 109 is performed after step 108 to send the live audio corresponding to the new live address to the client and stop the live audio played currently, so that switching of two live audios is implemented, and the user may switch to other live audio independently during the playing process of the current live audio.

Switching between the live audios during the playing process of the live audio may be implemented in steps 107˜109. When all the live audios on different channels are commentaries specific to the same competition, a synchronizing problem during the switching process of the live audios becomes a difficulty to solve. If synchronous switching is unenforceable, the user may miss the wonderful commentary on the match point, or a commentary audio is not synchronous with a competition video, which brings disturbance to the user.

While the switching operation in step 108 is to switch the live address, but not detect such parameters as the play time of the live audio corresponding to the live address; therefore, in order to solve the synchronizing problem during the switching process, the following implementation manner specific to step 101 is provided in the method for switching live audios provided by the embodiment of the present disclosure.

A unified network time protocol is adopted to set the sampling reference time of each live audio, and the play time stamp of each live audio is set based on the sampling reference time.

Because the audios of the hosts are not collected in the same device, and a unified reference time is not used during the process of collecting the live audios, the unified network time protocol NTP is adopted in step 101 to set the sampling reference time of each live audio, so that the live audios collected in different apparatuses have unified sampling reference time; meanwhile, the play time stamp PTS of each live audio may be set based on the sampling reference time, wherein the play time stamp PTS is an absolute play time stamp PTS, and the synchronous switching of the live audios may be performed according to the absolute PTS. Through this manner, not only the consistency of the sampling reference time of various live audios can be maintained from the source, but also the absolute play time stamp PTS may be served as a synchronizing parameter during the switching process to implement synchronous switching.

The process of serving the play time stamp PTS as the synchronizing parameter to perform the synchronous switching is performed in step 109. To be specific, the implementation manner is as follows.

The play time stamp of the live audio corresponding to the live address corresponding to the description information of the live audio which is pointed by the switching instruction is synchronized with the play time stamp of the live audio corresponding to the current live address, and the live audio corresponding to the live address corresponding to the description information of the live audio which is pointed by the switching instruction is sent based on the synchronized play time stamp.

In step 109, when sending the live audio which is pointed by the switching instruction, the absolute play time stamp of the live audio corresponding to the switching instruction will be compared with the absolute play time stamp of the current live audio, and the absolute play time stamps of the two are synchronized, and the live audio is sent based on the synchronized play time stamp. For example, during the switching operation, if the play time stamp of the current live audio A is 10:35, then the play time stamp of the live audio which is pointed by the switching instruction will be synchronized to 10:35 in step 109, and the live audio which is pointed by the switching instruction will be sent according to the play time stamp 10:35, while the client will also start switching to the new live audio from the play time stamp 10:35.

A live webcast program not only includes the live audios, but also includes live videos. For the live webcast program including both live audios and live videos, not only the synchronous switching of the live audios needs to be maintained, but also the synchronous playing of the live videos with the current live audio and the switched live audio needs to be maintained. A specific implementation manner is as follows.

The live metadata further includes: the description information of one live video and a corresponding relation between the description information of the live video and a video live address thereof, wherein the live video adopts a sampling reference time identical to that of the live audios on different channels, and has a play time stamp set based on the sampling reference time.

Through unifying the sampling reference time of the live video with the sampling reference time of the live audios on different channels, for example, adopting a unified network time protocol NTP, and meanwhile, setting the play time stamp of the live video based on the unified sampling reference time, the play time stamp of the live video is also an absolute play time stamp.

While the process of synchronously sending the live videos and the live audios according to the play time stamp may be implemented through step 105, and a specific implementation manner is as follows.

The play time stamp of the live video is synchronized with the play time stamp of the live audio corresponding to the current live address, and the live video and the live audio corresponding to the current live address are synchronously sent to the client.

After the streaming server and the client establish connection for the first time, according to the absolute play time stamp, the live videos and the live audios will be synchronously sent to the client according to the same play time stamp. While during the switching process of the live audios, the switching of the live audios is based on the absolute play time stamp; therefore, the current live audio and the switched live audio have the same play time stamp, so as to maintain that the switched live audio and continuously sent live videos also have the same play time stamp to implement synchronous playing of the live videos and the live audios.

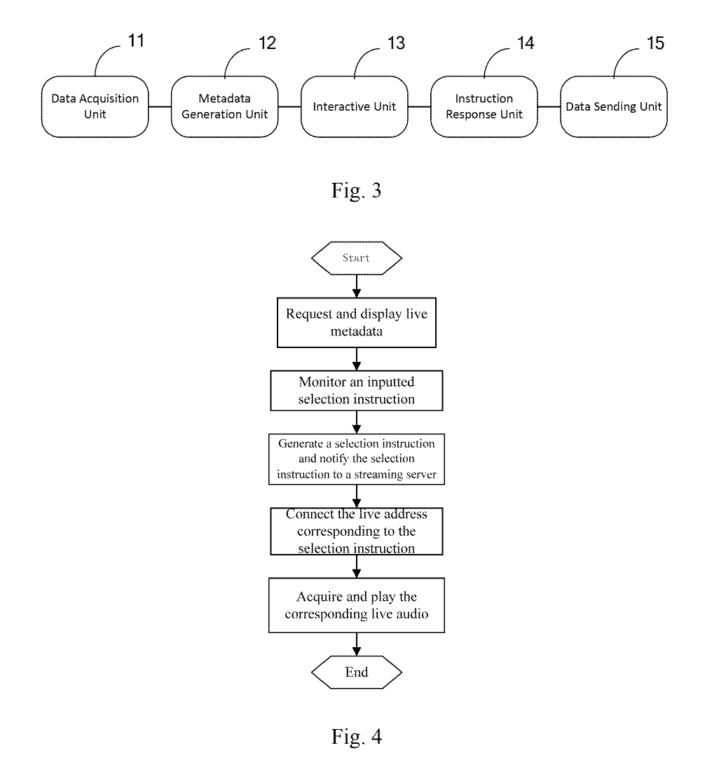

Referring to FIG. 3, some embodiments of the present disclosure provide a streaming server, including:

a data acquisition unit 11 configured to acquire live audios on different channels, and distribute a corresponding live address for each live audio;

a metadata generation unit 12 configured to construct live metadata, and add the description information of each live audio and a corresponding relation between the description information of the live audio and the live address in the live metadata;

an interactive unit 13 configured to send the live metadata to a client, and detect a selection instruction returned from the client;

an instruction response unit 14 configured to, if the selection instruction returned from the client is received in a predetermined time, set the live address corresponding to the description information of a live audio which is pointed by the selection instruction as the current live address; and

a data sending unit 15 configured to send the live audio corresponding to the current live address to the client.

Wherein, in the data acquisition unit 11, the live audios on different channels may be collected adopting a network distribution manner, and hosts may distribute in the same position or different positions. Because the audios of the hosts are not collected in the same apparatus, the data acquisition unit 11 needs to acquire the live audios of different hosts respectively in step 101, and publishes each live audio acquired to a live address distributed therefor.

The live metadata in the metadata generation unit 12 includes the description information of each live audio and the corresponding relation between the description information of the live audio and the live address. The interactive unit 13 will send the live metadata to the client, and the description information of each live audio in the live metadata will be displayed in a client, and a user may intuitively see the description information of each live audio, for example, a code rate, a sampling rate, an encoder type, host introduction, or the like, and the host introduction may further include: such information cared by the user as the avatar image, name, brief introduction, style, popularity degree and type of the host, etc. The user may find the host favored thereof, and click to select the description information of the live audio of the host. Then the interactive unit 13 will find the corresponding live address according to the selection of the user and the corresponding relation between the description information of the live audio and the live address.

The live metadata in the interactive unit 13 is sent after a connection request of the client is received. The streaming server includes live audios on different channels; therefore, after a connection between the streaming server and the client is established, neither the streaming server nor the client can determine which live audio shall be sent or played.

While there are various implementation manners of determining the live audio to be sent or played after the connection is established:

for example, it may be random playing, or the instruction response unit 14, when the selection instruction returned from the client is received in the predetermined time, may set the live address corresponding to the description information of the live audio which is pointed by the selection instruction as the current live address. The predetermined time is a reaction time reserved for the user, for example, the predetermined time may be 5 s or other duration. If the selection instruction returned from the client is not received in the predetermined time, the instruction response unit 14 may send a prompt to the user through the client, or continue to wait until the user inputs a selection instruction, and this will not be defined by the present disclosure. The selection instruction may be the clicking of the user on the description information of the live audio or a selection instruction in other manners inputted by the user, and will not be defined herein. According to the description information of the live audio which is pointed by the selection instruction, the instruction response unit 14 will set the address corresponding to the description information of the live audio as the current live address, and the data sending unit will publish the live audio to the current live address, while the client may also be connected to the current live address, so that the user may hear the live audio selected thereof.

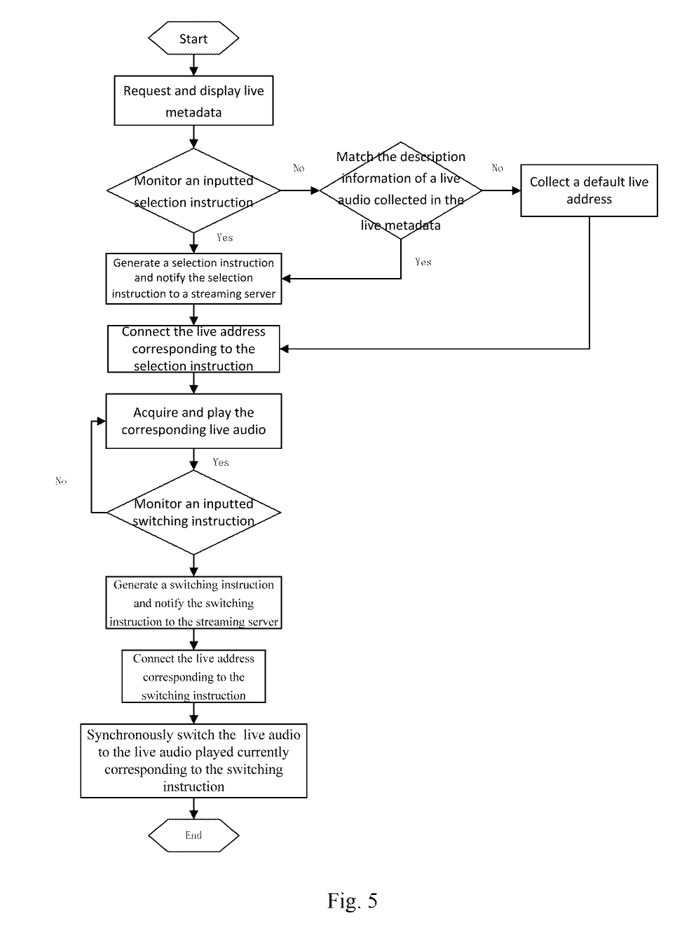

Reference to FIG. 4, if the instruction response unit 14 does not receive the selection instruction returned from the client in the predetermined time, besides the processing mode as described above, the instruction response unit 14 is also configured to: set a default live address as the current live address, wherein the default live address is preset and corresponding to the description information of one of live audios in the live metadata.

As described above, the predetermined time is a reaction time reserved for the user, while the data returned is not acquired in a long time, then the user will mistakenly believe that the connection is failed, which will affect the user experience. Therefore, the predetermined time cannot be too long; moreover, after exceeding the predetermined time, the streaming server needs to send data to a client server initiatively to maintain the user experience. The instruction response unit 14 will set one of the plurality of live addresses as a default live address; if the selection instruction returned from the client is not received in the predetermined time, then the default live address is directly served as the current live address, and the data sending unit 15 will directly send the corresponding live audio to the client.

Referring to FIG. 3, in the streaming server provided by some embodiments of the present disclosure:

the interactive unit 13 is also configured to detect a switching instruction returned from the client;

the instruction response unit 14 is also configured to switch the current live address into the live address corresponding to the description information of a live audio which is pointed by the switching instruction according to the description information of the live audio which is pointed by the switching instruction; and

the data sending unit 15 is also configured to send the live audio corresponding to the live address corresponding to the description information of the live audio which is pointed by the switching instruction to the client.

The instruction response unit 14 after receiving the selection instruction feed back by the client, has sent one of live audios to the client, and the client also starts playing the live audio; while, if the user finds that the live audio is not the one expected thereof during the playing process of the current live audio, then the user may initiate to switch the live audio through the client, and the switching processing of the live audio is as follows.

In step 107, the description information of each live audio in the live metadata is continuously displayed in the client, and the user may click the description information in any time; if the user clicks the description information of other live audio in the playing process of the current live audio, a switching instruction will be generated. Certainly, the switching instruction may also be generated using other manners, which will not be defined herein. The interactive unit 13 is just to detect the switching instruction occurred during the playing process of the current live audio.

After the switching instruction is detected, the instruction response unit 14 will switch the current live address into a new live address which is pointed by the switching instruction, and then the new live address just becomes the current live address. The data sending unit 15 will send the live audio corresponding to the new live address to the client and stop the live audio played currently, so that switching of two live audios is implemented, and the user may switch to other live audio independently during the playing process of the current live audio.

When all the live audios on different channels are commentaries specific to the same competition, a synchronizing problem during the switching process of the live audios becomes a difficulty to be solved. If synchronous switching cannot be implemented, the user may miss the wonderful commentary on the match point, or a commentary audio is not synchronous with a competition video, which brings disturbance to the user.

While the switching process in the instruction response unit 14 is to switch the live address, but not accurately detect such parameters as the play time of the live audio corresponding to the live address; therefore, in order to solve the synchronizing problem during the switching process, the following improvement specific to data acquisition unit 11 is provided in the method for switching live audios provided by the embodiment of the present disclosure.

The data acquisition unit 11 is also configured to: adopt a unified network time protocol to set the sampling reference time of each live audio, and set the play time stamp of each live audio based on the sampling reference time.

Because the audios of the hosts are not collected in the same device, and a unified reference time is not used during the process of collecting the live audios, the unified network time protocol NTP is adopted in the data acquisition unit 11 to set the sampling reference time of each live audio, so that the live audios collected in different apparatuses have unified sampling reference time; meanwhile, the play time stamp PTS of each live audio may be set based on the sampling reference time, wherein the play time stamp PTS is an absolute play time stamp PTS, and the synchronous switching of the live audios may be performed according to the absolute PTS. Through this manner, not only the consistency of the sampling reference time of various live audios can be maintained from the source, but also the absolute play time stamp PTS may be served as a synchronizing parameter during the switching process to implement synchronous switching.

The process of serving the play time stamp PTS as the synchronizing parameter to perform the synchronous switching is performed by the data sending unit 15. To be specific, the implementation manner is as follows.

The data sending unit 15 is also configured to synchronize the play time stamp of the live audio corresponding to the live address corresponding to the description information of the live audio which is pointed by the switching instruction with the play time stamp of the live audio corresponding to the current live address, and send the live audio corresponding to the live address corresponding to the description information of the live audio which is pointed by the switching instruction based on the synchronized play time stamp.

In the data sending unit 15, when sending the live audio which is pointed by the switching instruction, the absolute play time stamp of the live audio corresponding to the switching instruction will be compared with the absolute play time stamp of the current live audio, and the absolute play time stamps of the two are synchronized, and the live audio is sent based on the synchronized play time stamp. For example, during the switching instruction, if the play time stamp of the current live audio A is 10:35, then the data sending unit 15 will synchronize the play time stamp of the live audio which is pointed by the switching instruction to 10:35, and send the live audio which is pointed by the switching instruction according to the play time stamp 10:35, while the client will also start switching to the new live audio from the play time stamp 10:35.

A live webcast program not only includes the live audios, but also includes live videos. For the live webcast program including both live audios and live videos, not only the synchronous switching of the live audios needs to be maintained, but also the synchronous playing of the live videos with the current live audio and the switched live audio needs to be maintained. A specific implementation manner is as follows.

The live metadata further includes: the description information of one live video and a corresponding relation between the description information of the live video and a video live address thereof, wherein the live video adopts a sampling reference time identical to that of the live audios on different channels, and has a play time stamp set based on the sampling reference time.

Through unifying the sampling reference time of the live video with the sampling reference time of the live audios on different channels, for example, using a unified network time protocol NTP, and meanwhile, setting the play time stamp of the live video based on the unified sampling reference time, the play time stamp of the live video is also an absolute play time stamp.

While the process of synchronously sending the live videos and the live audios according to the play time stamp may be implemented by the data sending unit 15, and a specific implementation manner is as follows.

The data sending unit 15 is also configured to synchronize the play time stamp of the live video with the play time stamp of the live audio corresponding to the current live address, and synchronously send the live video and the live audio corresponding to the current live address to the client.

After the streaming server and the client establish connection for the first time, the live videos and the live audios will be synchronously sent to the client according to the absolute play time stamp and according to the same play time stamp. While during the switching process of the live audios, the switching of the live audios is based on the absolute play time stamp; therefore, the current live audio and the switched live audio have the same play time stamp, so as to maintain that the switched live audio and continuously sent live videos also have the same play time stamp to implement synchronous playing of the live videos and the live audios.

According to the method for switching audios and the streaming server provided by the embodiment of the present disclosure, live audios on different channels can be acquired at the same time, and the description information of the live audios on different channels are sent to the client to display, and the corresponding live audio is sent to the client to play according to the selection instruction returned from the client; and the live audios on different channels are provided for the user to select independently; if the switching instruction of the user occurred during the playing process of the live audio, then the synchronous switching and sending of the live audio are performed according to the absolute play time stamp of each live audio, to maintain the synchronization of the play time stamp of each live audio from the source and during the sending process, so that the synchronizing problem during the switching process is solved.

Referring to FIG. 4, some embodiments of the present disclosure provides a method for switching live audios, including the following steps.

In step 201, live metadata is requested from a streaming server, and the description information of live audios on different channels included in the live metadata is displayed.

In step 202, a selection instruction is detected whether to be inputted.

In step 203, if the inputted selection instruction is detected in a predetermined time, a selection instruction is generated according to the description information of a live audio which is pointed by the inputted selection instruction, and the selection instruction is notified to the streaming server.

In step 204, the live address corresponding to the selection instruction returned from the streaming server is connected.

In step 205, the corresponding live audio is acquired from the streaming server according to the live address, and played.

Wherein, in step 201, the streaming server includes the live audios on different channels and the live metadata, and the live metadata further includes the description information of the live audios on different channels and a corresponding relation between the description information of the live audio and the live address. In step 201, the live metadata is requested from the streaming server, and the description information of the live audios on different channels included in the live metadata is displayed, which may intuitively display the description information of the live audios on different channels to the user. The description information of the live audio includes: a code rate, a sampling rate, an encoder type, host introduction, or the like, and the host introduction may include: avatar image, name, brief introduction, style, popularity degree and type, or the like, which will not be specifically defined herein.

In step 202, the selection instruction is detected whether to be inputted, wherein the selection instruction may be clicking of the user on the description information of the live audio, and may be input of other forms, which will not be defined herein. If the inputted selection instruction is detected in step 202 in the predetermined time, then it needs to skip to step 203.

In step 203, the selection instruction is generated according to the description information of the live audio which is pointed by the inputted selection instruction, and is notified to the streaming server; because the live metadata in the streaming server includes the corresponding relation between the description information of the live audio and the live address, the streaming server may quickly find the corresponding the live address according to the selection instruction and return the live address.

In step 204, the live address corresponding to the selection instruction returned from the streaming server is connected, and the streaming server will publish the live audio to the corresponding live address.

In step 205, the corresponding live audio is acquired from the streaming server according to the live address, and played.

Wherein, the predetermined time is a reaction time reserved for the user, and the user may input the selection instruction in the predetermined time. That is, the user may select the description information of a live audio expected thereof the streaming server and the client establish connection, and the streaming server will perform steps 203˜205 according to the selection of the user; if the user does not input the selection instruction in the predetermined time, various manners such as sending a selection prompt to the user or continuing to wait until the user inputs the selection instruction, or initiatively pushing one of live audios to the client by the streaming server to play, may be adopted to implement the data connection of the live audio after step 202, which will not be defined herein.

But, all the foregoing implementation manners may lead that the user is incapable of hearing the live audios in a long time. In order to avoid that the client cannot hear the live audios in a long time after the streaming server and the client establish connection, it may skip to step 206 after step 202 if the inputted selection instruction is not detected in the predetermined time.

In step 206, the description information of a live audio matched with the description information of a live audio collected by a user is searched whether to exist in the live metadata; if yes, a selection instruction is generated according to the description information of the live audio matched, and the selection instruction is notified to the streaming server.

Wherein, the description information of the live audio collected by the user is stored in the client, and may be collected through a manner of setting a special marker for the description information of the live audio, while during the process of matching in the live metadata, a strategy used may be: completely consistent, i.e., the description information of the live audio collected by the user is completely consistent with the description information of the live audio in the live metadata; or partially consistent, for example, the name and the brief introduction of the host in the description information of the live audio collected by the user are consistent with the name and the brief introduction of the host in the description information of a certain live audio in the live metadata, while the other information is not consistent. The matching strategy may either be preset or independently set by the user, and will not be defined herein.

If the description information of the live audio matched with the description information of the live audio collected by the user is searched in the live metadata according to step 206, then it may skip to step 203 after step 206 to generate a selection instruction for the matched description information of the live audio collected by the user and notify the selection instruction to the streaming server.

If the description information of the live audio matched with the description information of the live audio collected by the user does not exist in the live metadata according to step 206, then it may skip to step 207 after step 206.

In step 207, a default live address returned from the streaming server is connected, wherein the default live address is preset in the streaming server and corresponding to the description information of one of live audios in the live metadata. It may skip to step 205 after step 207.

Referring to FIG. 5, after the steps 201˜205 shown in FIG. 4, the method for switching live audios provided by the embodiment of the present disclosure further includes the following steps.

In step 208, it is detected whether an inputted switching instruction exists; if no switching instruction is inputted, then step 205 is performed continuously; and if the switching instruction is inputted, then step 209 is performed.

In step 209, a switching instruction is generated according to the description information of a live audio which is pointed by the inputted switching instruction, and the switching instruction is notified to the streaming server.

In step 210, the live address corresponding to the switching instruction returned from the streaming server is connected.

In step 211, the live audio played currently is synchronously switched to the live audio acquired according to the live address corresponding to the switching instruction.

Based on the steps 201˜205, one of live audios has been acquired and the live audio is started playing; if the user finds that the live audio is not the one expected thereof during the playing process of the live audio, then the user may re-select the live audio expected thereof, and the switching steps in the live process are namely performed in steps 208˜211.

Wherein, in step 208, it is detected whether the inputted switching instruction exists, the inputted switching instruction is similar to the inputted selection instruction mentioned above, the implementation manners of the two may be the same, for example, the clicking of the user on the description information of the live audio or other input manners, while the application occasions of the two are different.

If the inputted switching instruction is detected in step 208, then it may skip to step 209 to generate the switching instruction according to the description information of the live audio which is pointed by the inputted switching instruction and notify the switching instruction to the streaming server; while, if the switching instruction is not detected to be inputted, then the switching step will not be performed, and the client continuously perform step 205 to continuously play the current live audio.

After step 209, the streaming server will find the live address corresponding to the description information of the live audio which is pointed by the switching instruction according to the switching instruction received and return the corresponding live address to the client. The live address returned from the streaming server is connected in step 210. The streaming server will publish the live audio to the corresponding live address.

In step 211 after step 210, the live address returned from the streaming server is connected and the corresponding live audio is acquired, and the live audio played currently is switched to the live audio acquired according to the live address corresponding to the switching instruction.

According to the method for switching audios described in the steps 101˜109 above, the streaming server may maintain the synchronization of multiple host audios while acquiring and sending; however, due to network transmission delay or system processing delay, the live audios on different channels may be not synchronized while arriving at the client.

After the switching instruction, the process of switching the live audio is performed in step 211. In order to maintain that the synchronous switching of the live audio may be implemented in step 211, an implementation manner adopted thereof is as follows.

The play time stamp of the live audio played currently is compared with the play time stamp of a live audio to be switched to.

If the play time stamp of the live audio to be switched to is less than the time stamp of the live audio played currently, the live audio to be switched to is arranged in a buffer zone, and reducing a play frame rate or suspending the live audio played currently, and the live audio to be switched to is played and the play frame rate is recovered when the play time stamp of the live audio to be switched to is equal to the time stamp of the live audio played currently.

If the play time stamp of the live audio to be switched to is greater than the time stamp of the live audio played currently, null packets in the live audio played currently are deleted, and the live audio to be switched to is played when the play time stamp of the live audio to be switched to is equal to the time stamp of the live audio played currently.

Wherein, the live audio to be switched to is a live audio acquired according to the live address corresponding to the switching instruction.

Wherein, the play time stamp of the live audio to be switched to and the time stamp of the live audio played currently are set based on the same sampling reference time.

As described above, the unified sampling reference time is adopted for the live audios on different channels acquired by the streaming server, and an absolute play time stamp is set for each live audio based on the sampling reference time. When the switching of the live audio is performed at the client in step 211, there are two different situations of the live audios: one is that the play time stamp of the live audio to be switched to is less than the time stamp of the live audio played currently, i.e., the live audio to be switched to falls behind the current live audio; at this moment, the live audio to be switched to is arranged in the buffer zone to buffer, while the playing speed of the current live audio is slowed or the current live audio is suspended, and the live audio to be switched to is played using a normal frame rate; another is that the play time stamp of the live audio to be switched to is greater than the time stamp of the live audio played currently, i.e., the live audio to be switched to is ahead of the current live audio, the client may quicken the playing of the current live audio through deleting the null packets in the current live audio, so as to play the live audio to be switched to using a normal frame rate after the play time stamp of the live audio to be switched to is equal to the play time stamp of the live audio played currently, wherein the null packets in the live audio refer to those packets with small sound energy.

A live webcast program not only includes the live audios, but also includes live videos. For the live webcast program including both live audios and live videos, not only the synchronous switching of the live audios need to be maintained, but also the synchronous playing of the live videos with the current live audio and the switched live audio needs to be maintained. A specific implementation manner is as follows.

The live metadata further includes: the description information of one live video and a corresponding relation between the description information of the live video and a video live address thereof, wherein the live video adopts a sampling reference time identical to that of the live audios on different channels, and has a play time stamp set based on the sampling reference time.

Through unifying the sampling reference time of the live video with the sampling reference time of the live audios on different channels, for example, adopting a unified network time protocol NTP, and meanwhile, setting the play time stamp of the live video based on the unified sampling reference time, the play time stamp of the live video is also an absolute play time stamp.

While the process of synchronously sending the live videos and the live audios according to the play time stamp may be implemented through step 205, and a specific implementation manner is as follows.

The live video is synchronously played according to the play time stamp of the live audio played currently.

After the streaming server and the client establish connection for the first time, the live videos and the live audios will be synchronously sent to the client according to the absolute play time stamp and according to the same play time stamp. While during the switching process of the live audios, the switching of the live audios is based on the absolute play time stamp; therefore, the current live audio and the switched live audio have the same play time stamp, so as to maintain that the switched live audio and continuously sent live videos also have the same play time stamp to implement synchronous playing of the live videos and the live audios.

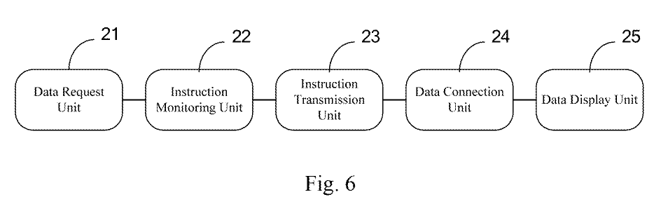

Referring to FIG. 6, the embodiment of the present disclosure provides a client, including:

a data request unit 21 configured to request live metadata from a streaming server, and display the description information of live audios on different channels included in the live metadata;

an instruction detecting unit 22 configured to detect whether an inputted selection instruction exists;

an instruction transmission unit 23 configured to, if the inputted selection instruction is detected in a predetermined time, generate a selection instruction according to the description information of a live audio which is pointed by the inputted selection instruction, and notify the selection instruction to the streaming server;

a data connection unit 24 configured to connect the live address corresponding to the selection instruction returned from the streaming server; and

s a data display unit 25 configured to acquire the corresponding live audio from the streaming server according to the live address, and play.

Wherein, the data request unit 21 is configured to request the live metadata from the streaming server and display the live metadata, and may intuitively display the description information of various live audios to a user. The streaming server includes the live audios on different channels and the live metadata, and the live metadata includes the description information of the live audios on different channels and a corresponding relation between the description information of the live audio and the live address. The description information of the live audio includes: a code rate, a sampling rate, an encoder type, host introduction, or the like, and the host introduction may further include: avatar image, name, brief introduction, style, popularity degree and type, or the like, which will not be specifically defined herein.

The instruction detecting unit 22 is configured to detect whether the inputted selection instruction exists, wherein the selection instruction may be clicking of the user on the description information of the live audio, and may be input of other forms, which will not be defined herein.

If the detection unit 22 detects the inputted selection instruction in the predetermined time, then the instruction transmission unit 23 will generate the selection instruction according to the description information of the live audio which is pointed by the inputted selection instruction, and notify the selection instruction to the streaming server; because the live metadata in the streaming server includes the corresponding relation between the description information of the live audio and the live address, the streaming server may quickly find the corresponding the live address according to the selection instruction and return the live address.

The data connection unit 24 will connect the live address corresponding to the selection instruction returned from the streaming server, and the streaming server will publish the live audio to the corresponding live address.

The data display unit 25 will request to acquire the corresponding live audio from the streaming server according to the live address, and play.

Wherein, the predetermined time is a reaction time reserved for the user, and the user may input the selection instruction in the predetermined time. That is, the user may select the description information of a live audio expected thereof the streaming server and the client establish connection, and the streaming server will send one of live audios to the client; if the user does not input the selection instruction in the predetermined time, the instruction transmission unit 23 may adopt various manners such as sending a selection prompt to the user or continuing to wait until the user inputs the selection instruction, or initiatively pushing one of live audios to the client by the streaming server to play, to implement the data connection of the live audio, which will not be defined herein.

But, all the foregoing implementation manners of the instruction transmission unit 23 may lead the user to be incapable of hearing the live audios in a long time. In order to avoid that the client cannot hear the live audios in a long time after the streaming server and the client establish connection, the instruction transmission unit 23 is also configured to:

if the inputted selection instruction is not detected in the predetermined time, search whether the description information of a live audio matched with the description information of a live audio collected by a user exists in the live metadata; if yes, generate a selection instruction according to the description information of the live audio matched, and notify the selection instruction to the streaming server.

Wherein, the description information of the live audio collected by the user is stored in the client, and may be collected through a manner of setting a special marker for the description information of the live audio, while during the process of matching in the live metadata, a strategy used may be: completely consistent, i.e., the description information of the live audio collected by the user is completely consistent with the description information of the live audio in the live metadata; or partially consistent, for example, the name and the brief introduction of the host in the description information of the live audio collected by the user are consistent with the name and the brief introduction of the host in the description information of a certain live audio in the live metadata, while the other information is not consistent. The matching strategy may either be preset or independently set by the user, and will not be defined herein.

If the instruction transmission unit 23 searches the description information of a live audio matched with the description information of a live audio collected by a user exists in the live metadata, then a selection instruction is generated according to the matched description information of the live audio collected by the user, and the selection instruction is notified to the streaming server.

If the instruction transmission unit 23 does not search the description information of the live audio matched with the description information of the live audio collected by the user in the live metadata, then the data connection unit 24 will connect a default live address returned from the streaming server is connected, wherein the default live address is preset in the streaming server and corresponding to the description information of one of live audios in the live metadata.

According to the selection instruction generated by the instruction transmission unit 23, the client has acquired one of live audios and starts playing the live audio; if the user finds that the live audio is not the one expected thereof during the playing process of the live audio, then the user may re-select the live audio expected thereof, and the switching process is implemented by the following units.

The instruction detecting unit 22 is also configured to: detect whether an inputted switching instruction exists.

The instruction transmission unit 23 is also configured to: if yes, generate a switching instruction according to the description information of a live audio which is pointed by the inputted switching instruction, and notify the switching instruction to the streaming server.

The data connection unit 24 is also configured to: connect the live address corresponding to the switching instruction returned from the streaming server.

The data display unit 25 is also configured to: synchronously switch the live audio played currently to a live audio acquired according to the live address corresponding to the switching instruction.

Wherein, the instruction detecting unit 22 detects whether the switching instruction is inputted, the inputted switching instruction is similar to the inputted selection instruction which is mentioned above, the implementation manners of the two may be the same, for example, the clicking of the user on the description information of the live audio or other input manners, while the application occasions of the two are different.

If the inputted switching instruction is detected in the instruction detecting unit 22, then the instruction transmission unit 23 will generate the switching instruction according to the description information of the live audio which is pointed by the inputted switching instruction and notify the switching instruction to the streaming server; while, if the instruction detecting unit 22 does not detect the inputted switching instruction, then the switching step will not be performed, and the data display unit 25 will continuously play the current live audio.

After the instruction transmission unit 23 sends the switching instruction, the streaming server will find the live address corresponding to the description information of the live audio pointed by the switching instruction according to the switching instruction received and return the corresponding live address to the client. The data connection unit 24 namely connects the live address returned from the streaming server. The streaming server will publish the live audio to the corresponding live address.

The data display unit 25 namely connects the live address returned from the streaming server and acquires the corresponding live audio, and switches the live audio played currently to the live audio acquired according to the live address corresponding to the switching instruction.

According to the streaming server as shown in FIG. 3, the streaming server may maintain the synchronization of multiple host audios while acquiring and sending; however, due to network transmission delay or system processing delay, the live audios on different channels may be not synchronized while arriving the client.

After the switching instruction, the process of switching the live audio is performed by the data display unit 25. In order to maintain the synchronous switching of the live audio in the client, an implementation manner adopted by the data display unit 25 is as follows.

The play time stamp of the live audio played currently is compared with the play time stamp of a live audio to be switched to.

If the play time stamp of the live audio to be switched to is less than the time stamp of the live audio played currently, the live audio to be switched to is arranged in a buffer zone, and reducing a play frame rate or suspending the live audio played currently, and the live audio to be switched to is played and the play frame rate is recovered when the play time stamp of the live audio to be switched to is equal to the time stamp of the live audio played currently.

If the play time stamp of the live audio to be switched to is greater than the time stamp of the live audio played currently, null packets in the live audio played currently are deleted, and the live audio to be switched to is played when the play time stamp of the live audio to be switched to is equal to the time stamp of the live audio played currently.

Wherein, the live audio to be switched to is a live audio acquired according to the live address corresponding to the switching instruction.

Wherein, the play time stamp of the live audio to be switched to and the time stamp of the live audio played currently are set based on the same sampling reference time.

As described above, the unified sampling reference time is adopted for the live audios on different channels acquired by the streaming server, and an absolute play time stamp is set for each live audio based on the sampling reference time. When the data display unit 25 performs switching of the live audio at the client, there are two different situations of the live audios: one is that the play time stamp of the live audio to be switched to is less than the time stamp of the live audio played currently, i.e., the live audio to be switched to falls behind the current live audio; at this moment, the live audio to be switched to is arranged in the buffer zone to buffer, while the playing speed of the current live audio is slowed or the current live audio is suspended, and the live audio to be switched to is played using a normal frame rate; another is that the play time stamp of the live audio to be switched to is greater than the time stamp of the live audio played currently, i.e., the live audio to be switched to is ahead of the current live audio, the client may quicken the playing of the current live audio through deleting the null packets in the current live audio, so as to play the live audio to be switched to using a normal frame rate after the play time stamp of the live audio to be switched to is equal to the play time stamp of the live audio played currently, wherein the null packets in the live audio refer to those packets with small sound energy.

A live webcast program not only includes the live audios, but also includes live videos. For the live webcast program including both live audios and live videos, not only the synchronous switching of the live audios needs to be maintained, but also the synchronous playing of the live videos with the current live audio and the switched live audio needs to be maintained. A specific implementation manner is as follows.

The live metadata further includes: the description information of one live video and a corresponding relation between the description information of the live video and a video live address thereof, wherein the live video adopts a sampling reference time identical to that of the live audios on different channels, and has a play time stamp set based on the sampling reference time.

Through unifying the sampling reference time of the live video with the sampling reference time of the live audios on different channels, for example, using a unified network time protocol NTP, and meanwhile, setting the play time stamp of the live video based on the unified sampling reference time, the play time stamp of the live video is also an absolute play time stamp.

While the process of synchronously sending the live videos and the live audios according to the play time stamp may be implemented by the data display unit 25, and a specific implementation manner is as follows.

The live video is synchronously played according to the play time stamp of the live audio played currently.

After the streaming server and the client establish connection for the first time, the live videos and the live audios will be synchronously sent to the client according to the absolute play time stamp and according to the same play time stamp. While during the switching process of the live audios, the switching of the live audios is based on the absolute play time stamp; therefore, the current live audio and the switched live audio have the same play time stamp, so as to maintain that the switched live audio and continuously sent live videos also have the same play time stamp to implement synchronous playing of the live videos and the live audios.

According to the method for switching audios and the client provided by the embodiment of the present disclosure, the description information of live audios on different channels that can be selected by the user are displayed at the client, and the corresponding live audio is acquired from the streaming server according to the inputted selection instruction by the user, so that the user may select the live audio independently; during the playing process of the live audio, the live audio corresponding to the switching instruction may also be acquired according to the inputted switching instruction by the user, and the synchronous switching of the live audio to be switched to and the current live audio can be implemented according to the absolute play time stamps of the two; moreover, the synchronous playing of the live videos with the current live audio and the switched live audio can be maintained in a circumstance that the live webcast not only includes audios but also includes videos.

The embodiment will be described in details hereinafter by taking the live webcast of an NBA basketball competition as an example.

At the streaming server side: live videos collected on the scene and host live audios on different channels collected at different positions are acquired, a unified network time protocol NTP is adopted for the host live audios on different channels as the sampling reference time, and the absolute PTS of each live audio is set based on the NTP, the live audios on different channels are collected at the same time, based on the same sampling reference time, and the absolute PTS thereof is set based on the NTP, thus ensuring the synchronization of the live audios on different channels from the source; afterwards, the description information of the live audio including each host description is sent to the client for the user to select, for example, the user selects an host Xiao Jia through the client, then the streaming server will send the live audio of the host Xiao Jia to the client, while if the user finds that the commentary of Xiao Jia is not expected thereof, and an host Xiao Bing may comply with the hobby thereof according to the description information of the live audio, the user will click the introduction of the host Xiao Bing, then the streaming server will send the live audios of the host Xiao Bing to the client and stop sending the live audio of the host Xiao Jia, and synchronous switching and sending will be maintained according to the absolute PTS of the two live audios during the sending process.

At the client side: after the live metadata in the streaming is acquired, the detailed introductions of multiple hosts will be displayed in the client, the user clicks the description information of the host Xiao Jia from the multiple hosts, and the client notifies the selection of the user to the streaming server and connects the corresponding live address of the host Xiao Jia returned from the streaming server, and acquires the live audios of the host Xiao Jia; after listening for a period of time, the user finds that the standpoint of the host Xiao Jia is not consistent with the standpoint thereof, and wants to switch to an host Xiao Bing having the standpoint consistent with the standpoint thereof, then the switching instruction may be notified to the streaming server by clicking the description information of the host Xiao Bing only, and the live audio of the host Xiao Bing may be acquired from the streaming server; Due to such problems as network transmission delay, after the live audio of the host Xiao Bing reaches the client, the absolute play time stamp thereof is less than the play time stamp of the currently played host Xiao Jia, then the client will reduce the play frame rate of the live audio of the currently played host Xiao Jia or suspend playing the live audio of the currently played host Xiao Jia; when the absolute time stamp of the live audio of the host Xiao Bing is equal to the absolute time stamp of the live audio of the host Xiao Jia, the live audios of the host Xiao Bing and the host Xiao Jia are synchronously switched to play the live audio of the host Xiao Bing; the synchronous switching maintains that the user will not miss the commentary of any match point, and avoid any pause and waiting situations.

The device embodiments described above are only exemplary, wherein the units illustrated as separation parts may either be or not physically separated, and the parts displayed by units may either be or not physical units, i.e., the parts may either be located in the same place, or be distributed on a plurality of network units. A part or all of the modules may be selected according to an actual requirement to achieve the objectives of the solutions in some embodiments. Those having ordinary skills in the art may understand and implement without going through creative work.

Through the above description of the implementation manners, those skilled in the art may clearly understand that each implementation manner may be achieved in a manner of combining software and a necessary common hardware platform, and certainly may also be achieved by hardware. Based on such understanding, the foregoing technical solutions essentially, or the part contributing to the prior art may be implemented in the form of a software product. The computer software product may be stored in a storage medium such as a ROM/RAM, a diskette, an optical disk or the like, and includes several instructions for instructing a computer apparatus (which may be a personal computer, a server, or a network apparatus so on) to execute the method according to each embodiment or some parts of some embodiments.

It should be finally noted that the above embodiments are only configured to explain the technical solutions of the present disclosure, but are not intended to limit the present disclosure. Although the present disclosure has been illustrated in detail according to the foregoing embodiments, those having ordinary skills in the art should understand that modifications can still be made to the technical solutions recited in various embodiments described above, or equivalent substitutions can still be made to a part of technical features thereof, and these modifications or substitutions will not make the essence of the corresponding technical solutions depart from the spirit and scope of the technical solutions of some embodiments of the present disclosure.

What is claimed is:

1. A method for switching live audios, comprising:
at an electronic device:
acquiring live audios on different channels, and
distributing a corresponding live address for each live audio;
constructing live metadata, and
adding the description information of each live audio and a corresponding relation between the description information of the live audio and the live address to the live metadata;
sending the live metadata to a client, and
detecting a selection instruction returned from the client;
if the selection instruction returned from the client is received in a predetermined time, setting the live address corresponding to the description information of a live audio which is pointed by the selection instruction as the current live address; and
sending the live audio corresponding to the current live address to the client.

2. The method according to claim 1, comprising:
setting a default live address as the current live address if the selection instruction returned from the client is not received in the predetermined time, wherein the default live address is preset and corresponding to the description information of one of the live audios in the live metadata.

3. The method according to claim 1, further comprising:
detecting a switching instruction returned from the client;
switching the current live address into the live address corresponding to the description information of a live audio which is pointed by the switching instruction according to the description information of the live audio which is pointed by the switching instruction; and
sending the live audio corresponding to the live address corresponding to the description information of the live audio which is pointed by the switching instruction to the client.

4. The method according to claim 1, wherein the acquiring the live audios on different channels further comprises:
adopting a unified network time protocol to set the sampling reference time of each live audio, and setting the play time stamp of each live audio based on the sampling reference time.

5. The method according to claim 4, wherein the sending the live audio corresponding to the live address corresponding to the description information of the live audio which is pointed by the switching instruction to the client further comprises:
synchronizing the play time stamp of the live audio corresponding to the live address corresponding to the description information of the live audio which is pointed by the switching instruction with the play time stamp of the live audio corresponding to the current live address, and
sending the live audio corresponding to the live address corresponding to the description information of the live audio which is pointed by the switching instruction based on the synchronized play time stamp.

6. The method according to claim 4, wherein the live metadata further comprises:
the description information of one live video and a corresponding relation between the description information of the live video and a video live address thereof, wherein the live video adopts a sampling reference time identical to that of the live audios on different channels, and has a play time stamp set based on the sampling reference time.

7. The method according to claim 6, wherein the sending the live audio corresponding to the current live address to the client further comprises:
synchronizing the play time stamp of the live video with the play time stamp of the live audio corresponding to the current live address, and synchronously sending the live video and the live audio corresponding to the current live address to the client.

8. A method for switching live audios, comprising:
at an electronic device:
requesting live metadata from a streaming server, and displaying the description information of live audios on different channels comprised in the live metadata;
detecting whether an inputted selection instruction exists;
if the inputted selection instruction is detected in a predetermined time, generating a selection instruction according to the description information of a live audio which is pointed by the inputted selection instruction, and notifying the selection instruction to the streaming server;
connecting the live address corresponding to the selection instruction returned from the streaming server; and
acquiring the corresponding live audio from the streaming server according to the live address, and playing the corresponding live audio.

9. The method according to claim 8, further comprising:
if the inputted selection instruction is not detected in the predetermined time,
searching whether the description information of a live audio matched with the description information of a live audio collected by a user exists in the live metadata;
if yes, generating a selection instruction according to the description information of the live audio matched, and notifying the selection instruction to the streaming server.

10. The method according to claim 9, further comprising:
if the description information of the live audio matched with the description information of the live audio collected by the user do not exist,
connecting a default live address returned from the streaming server,
wherein the default live address is preset in the streaming server and corresponding to the description information of one of live audios in the live metadata.

11. The method according to claim 8, further comprising:
detecting whether an inputted switching instruction exists;
if yes, generating a switching instruction according to the description information of a live audio which is pointed by the inputted switching instruction, and notifying the switching instruction to the streaming server;
connecting the live address corresponding to the switching instruction returned from the streaming server; and
synchronously switching the live audio played currently to a live audio acquired according to the live address corresponding to the switching instruction.

12. The method according to claim 11, wherein the synchronously switching the live audio played currently to the live audio acquired according to the live address corresponding to the switching instruction further comprises:
comparing the play time stamp of the currently played live audio with the play time stamp of a live audio to be switched to;
if the play time stamp of the live audio to be switched to is less than the time stamp of the live audio played currently, arranging the live audio to be switched to in a buffer zone,
reducing a play frame rate or suspending the live audio played currently, and
playing the live audio to be switched to and recovering the play frame rate when the play time stamp of the live audio to be switched to is equal to the time stamp of is the live audio played currently; and
if the play time stamp of the live audio to be switched to is greater than the time stamp of the live audio played currently,
deleting null packets in the live audio played currently,
playing the live audio to be switched to when the play time stamp of the live audio to be switched to is equal to the time stamp of the live audio played currently;
wherein the live audio to be switched to is a live audio acquired according to the live address corresponding to the switching instruction; and
wherein the play time stamp of the live audio to be switched to and the time stamp of the live audio played currently are set based on the same sampling reference time.

13. The method according to claim 8, wherein the live metadata further comprises:
the description information of one live video and a corresponding relation between the description information of the live video and a video live address thereof, wherein the live video adopts a sampling reference time identical to that of the live audios on different channels, and has a play time stamp set based on the sampling reference time.

14. The method according to claim 13, further comprising:
synchronously playing the live video according to the play time stamp of the live audio played currently.
